(19) United States
(12) Patent Application Publication
(10) Pub. No.: US 2006/0005401 A1
(43) Pub. Date: Jan. 12, 2006

(54) Power tool

(76) Inventors: Gianni Borinato, Schio (IT); Paolo Andriolo, Suzhou (CN)

Correspondence Address: FULWIDER PATTON LEE & UTECHT, LLP, 200 OCEANGATE, SUITE 1550, LONG BEACH, CA, 90802, US

(21) Appl. No.: 11/169,559

(22) Filed: Jun. 29, 2005

(30) Foreign Application Priority Data
Jun. 29, 2004 (IT) VI2004A000157

(51) Int. Cl. B23D 45/16

(52) U.S. Cl. 30/388

(57) ABSTRACT

The present invention relates to a power tool (1) such as a circular saw comprising a tool element (2) such as a circular blade having a tool element axis (X), a motor (4) having a shaft (5) which defines a longitudinal shaft axis (Y), a handgrip (7, 37) for the operator to support the power tool (1) and a power switch (8) arranged on the handgrip (7, 37). The motor (4), the handgrip (7, 37) and the power switch (8) are rigidly connected to each other to form a block or unit (9) which assists the comfort of the user. The unit (9) is coupled to the tool element housing (3) but it may be rotated by the operator with respect to the tool element housing (3) around a unit rotation axis which may be coincident with the motor axis (Y) or an axis parallel thereto.

### FIELD OF THE INVENTION

The present invention relates to a power tool (preferably a circular saw) comprising a novel handle arrangement.

### DESCRIPTION OF THE PRIOR ART

Power tools are generally composed of a housing or main body inside which there is arranged an electric motor having a shaft connected to a rotary tool element via a gear system to reduce speed. The housing generally includes a handgrip to allow the user to hold and drive the tool element. In most cases, the main body is provided with a shoe plate to support the machine on a work-piece during operation. In a circular saw, the housing is adjustable relative to the shoe plate to change the depth of cut of the saw blade. In the case of (for example) a circular saw or a bench grinder, the tool element (eg a circular blade) can be partially housed by a housing to protect the user during operation.

Almost all commercial power tools nowadays have the handgrip integrally formed with the housing and the rotary tool element. Such power tools have the drawback that during operation on a vertical or an oblique work piece or on a very long work piece, the operator has to move a relatively long distance thereby extending his arm and hand. The fixed position of the handgrip obstructs the manual control of the machine and the accuracy of the work. It is disadvantageous to productivity. Most importantly, it may be dangerous to the operator.

The same drawbacks arise when the depth of the cut of a saw blade is adjusted. In this case, while the position of the tool element relative to the shoe plate is changed, the position of the handgrip changes too resulting in the drawbacks mentioned above.

U.S. Pat. No. 4,516,324 discloses a circular saw which has a one-piece housing and a rotatable handgrip. The handgrip can be positioned in two positions, a first position being a “push position” wherein the tool is pushed straight in the cutting direction and a second position being a “top position” wherein the handgrip is adjusted vertically on the tool. This arrangement gives the user the option to change the handgrip between two positions only. Moreover, the steps for adjusting the handgrip between the two positions are quite complex and lengthy. In practice it is necessary to unplug the power cord for safety reasons, to unlock the handgrip, to adjust its position, to lock the handgrip, to plug the power cord in again and so on. Such a lengthy operation may lead the user not to change the handgrip position at all.

U.S. Pat. No. 6,588,112 discloses a circular saw in which the motor housing and the blade housing form a unit and are fixed to a shoe plate. For adjusting the handgrip, the tool has a complex mechanism with a lever and a spring to prevent the power switch being accidentally switched on. Over prolonged periods, in the mechanism itself as well as in other parts that are subjected to continued stress, a degree of play may be generated. Excessive play between the lever and the switch may compromise the functionality of the machine and possibly the safety which may constitute a risk to the user. Secondly, the electric cable that connects the power switch (which is arranged on a movable handgrip and which rotates (pivots) along with the handgrip) to the motor is subjected to torsion and bending each time the handgrip is adjusted to a new position. Even if a soft and flexible cable is used, over time there is an increased risk of the cable breaking leading to the possibility of a dangerous electrical short circuit.

### OBJECTS OF THE INVENTION

It is an object of the invention to provide a power tool which is easy and comfortable to use, efficient and (most importantly) very safe.

Another object of the present invention is to provide a power tool that allows the user to adjust the position of the handgrip in a continuous, easy and safe way.

It is still another object of the present invention to provide a power tool that is lightweight whilst being strong and reliable.

It is still another object of the present invention to provide a power tool that allows the user to perform accurate work even during a change in the position of the handgrip.

It is still another object of the present invention to provide a power tool with high reliability and long life.

It is still another object of the present invention to provide a power tool that avoids disadvantages of the prior art mentioned above.

### SUMMARY OF THE INVENTION

Viewed from a first aspect the preset invention provides a power tool comprising;
a) a tool element for manipulating a workpiece,
b) a tool element housing to accommodate and to support the tool element,
c) a motor having a longitudinal shaft axis,
d) a motor housing for supporting the motor,
c) a transmission device for transferring energy from the motor to the tool element,
f) a handgrip for moving the tool element with respect to the workpiece, wherein the motor housing and the handgrip are a monolithic unit which is rotatable relative to the tool element housing around a unit rotation axis and
g) a coupling member for operatively (eg rotationally) coupling the unit to the tool element housing.

In accordance with the present invention, the tool element housing and the motor housing are not fixed to each other to form one piece but instead can be rotated relative to each other by the operator. This advantageously allows the user to adjust the handgrip position without the need to disable the power switch in a simple, safe and effective manner leading to increased productivity. For example, during regular operation the unit will be held such that the unit and tool element housing are in a relative angular disposition chosen by the operator. The desired relative angular disposition will change according to the working situation. For example, after having performed sawing work close-up, the operator will chose another relative angular disposition for doing more remote sawing work on the work-piece.

Preferably the handgrip comprises:
a first handgrip part having a first handgrip axis spaced apart from and essentially perpendicular to the longitudinal shaft axis. Preferably the first handgrip axis is slightly curved.

Preferably the handgrip comprises:
a second handgrip part having a second handgrip axis. Preferably the second handgrip axis is essentially parallel to the longitudinal shaft axis. Preferably the second handgrip axis is slightly curved.

The first and second handgrip parts are typically angularly displaced (preferably by about 90°). The second handgrip part may be disposed adjacent to about the midsection of the first handgrip part. An embodiment with first and second handgrips is advantageously very comfortable for the operator during precise manipulation of a workpiece.

The first handgrip part may have a rearward grip member. The grip member may have a first handgrip axis which is spaced apart from and essentially perpendicular to the longitudinal shaft axis. The second handgrip part may have a rearward grip member having a second handgrip axis. The second handgrip axis may be arranged essentially parallel to the longitudinal shaft axis.

Preferably the unit is rotatable by an angle of 90 degrees or less relative to the tool element housing. Preferably the unit is stepwise, incrementally or continuously rotatable. Angle delimiters may be positioned to prevent over-rotation. The unit may be rotated by the operator with respect to the tool element housing around a unit rotation axis which may be coincident with the longitudinal shaft axis or an axis parallel thereto.

Preferably whilst the motor is static, the unit is fixable (eg locked) at a desired angular disposition relative to the tool element housing.

Preferably the unit is slidably rotatable relative to the tool element housing. For example, adjacent end faces of the unit and the tool element housing may be slidingly coupled by the coupling member. A sliding mechanism may be used to facilitate slidable coupling. The coupling member typically couples the unit to the tool element housing axially (eg along an axis substantially coincident with the longitudinal shaft axis or substantially parallel thereto such as the axis of the tool element).

In a preferred embodiment, the coupling member comprises:
a sliding mechanism for allowing sliding rotation between the unit and the tool element housing. Preferably the sliding mechanism is in the form of a sliding ring. The sliding ring may be formed of rubber which allows for a sliding rotation between the unit and the tool housing. The sliding mechanism may be arranged between a first and a second ring-shaped coupling portion.

Particularly preferably the coupling member comprises:
a first ring-shaped coupling portion and a second ring-shaped coupling portion, wherein the first coupling portion is firmly connected to (or is integral with) the unit and the second coupling portion is firmly connected to (or is integral with) the tool element housing, and wherein the sliding mechanism is arranged between the first coupling portion and the second coupling portion.

More preferably a first and a second annular recess are provided on the outer circumferential surface of the first and second coupling portion respectively and the coupling member further comprises:
a split ring composed of a flexible material, wherein the split ring has a first annular extension and a second annular extension on its inner circumferential surface, the first and second recesses being adapted to receive the first and second annular extension respectively (ie when the split ring is open) and a closure device for closing the split ring.

Even more preferably the annular recesses and the annular extensions have oblique walls on which a pressure is exerted when the split ring is closed.

Preferably the split ring is made of steel. The sliding mechanism may be confined within the split ring.

The tool element is typically a rotary tool element. Preferably the tool element is a saw blade (eg a circular saw blade).

Preferably the coupling member is of the bayonet-type. Particularly preferably the bayonet-type coupling member comprises:
a female element connected to or integral with the unit and
a male element connected to or integral with the tool element housing.

The male element may include the second ring-shaped coupling portion. The female element may include the first ring-shaped coupling portion.

In a preferred embodiment the female element comprises:
a plurality of recesses and a plurality of radial teeth of predetermined height (h) therebetween and
wherein the male element comprises:
a plurality of radial protrusions each having a predetermined thickness (d) for insertion into the recesses such that by rotation of the male element around the unit rotation axis, each of the radial protrusions engages the rear of one of the radial teeth.

Preferably the power tool further comprises:
a braking system between the unit and the tool element housing.

Preferably the power tool further comprises:
a damping element for damping pulses between the tool element housing and the unit. Preferably the damping element is made of a viscous material or is a shock absorber.

Preferably the unit rotation axis is coincident with the longitudinal shaft axis or an axis parallel thereto (eg the tool element axis).

A power switch connecting the motor to the mains supply may be arranged on the handgrip (eg to be operated by the forefinger of the operator).

Additional features and advantages of the present invention will become evident by the detailed description of a preferred embodiment which follows.

### BRIEF DESCRIPTION OF THE DRAWINGS

FIG. 1 is a perspective view of a circular saw according to an embodiment of the present invention;

FIG. 2 is an exploded view of the circular saw illustrated in FIG. 1;

FIG. 3 is a perspective view of parts of the circular saw illustrated in FIG. 2, wherein the element 11 (on the left side) is turned around compared with the element 11 as illustrated in FIG. 2;

FIG. 4 is an enlarged view corresponding to the exploded view of the circular saw illustrated in FIG. 2,

FIG. 5 is a partial cross-sectional view of an axial plane crossing the axis Y along the arrows V of FIG. 1;

FIG. 6 is a cross-sectional view of a coupling member arranged between the tool housing and the monolithic unit of the embodiment of FIG. 1; and

FIG. 7 is a partial view of the coupling member illustrated in FIG. 6 wherein the male element of the coupling member has been rotated about axis Y.

### DETAILED DESCRIPTION OF THE PREFERRED EMBODIMENTS

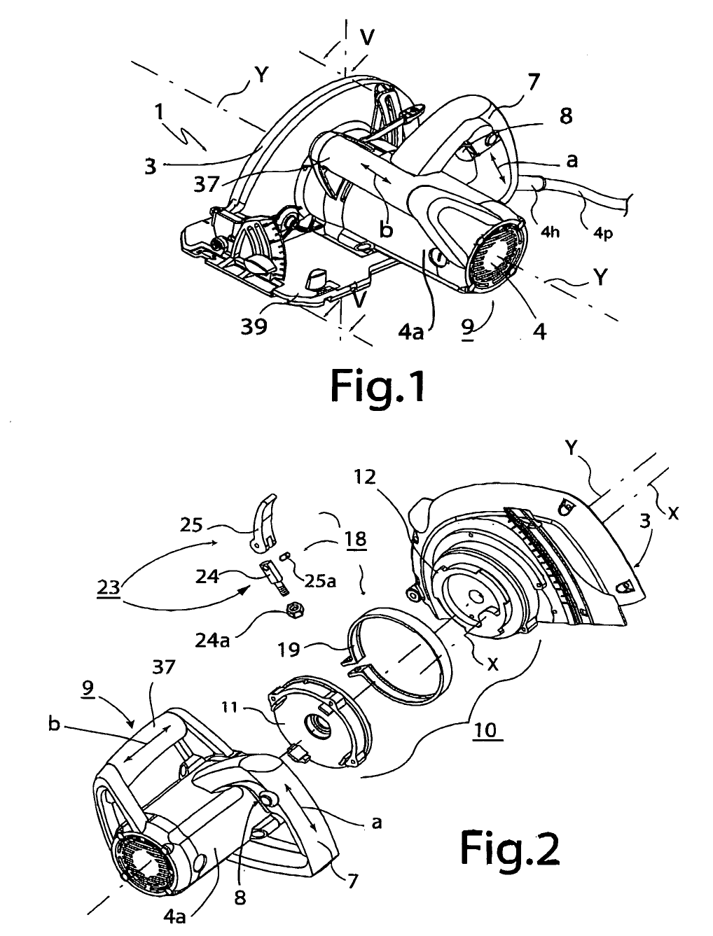

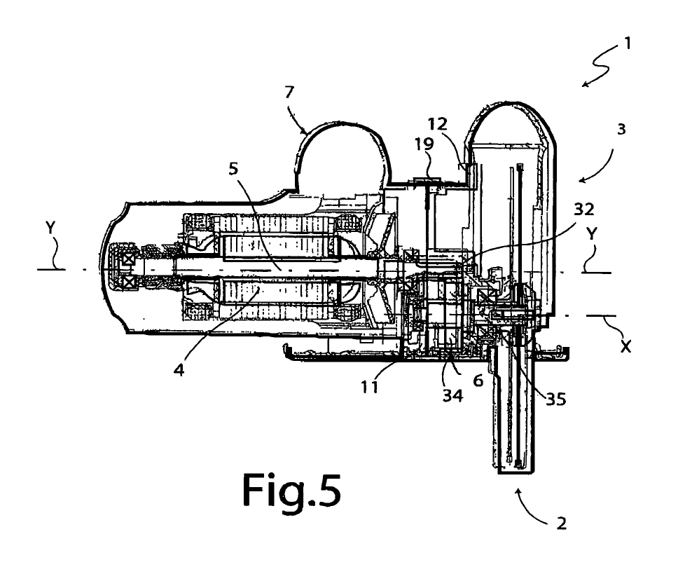

The power tool illustrated in FIGS. 1-7 is a circular saw 1. The circular saw 1 comprises a circular blade 2 which defines a tool axis X, a safety housing 3 to accommodate and to support the circular blade 2 rotatably around the tool axis X and a motor 4 having a motor housing 4a and a shaft 5 which defines a longitudinal shaft axis Y parallel to the tool axis X A transmission device 6 includes a gear system for coupling the shaft 5 to the circular blade 2 so as to transfer energy from the motor 4 to the circular blade 2. Favourably, the transmission device 6 has a speed reduction mechanism that comprises a pinion 32 positioned at the end of the motor shaft 5. The pinion 32 drives a gear system 34 which is connected to the shaft 35 of the circular blade 2 (see FIG. 5). It will be noted that in this case the tool axis X and the longitudinal shaft axis Y are substantially parallel to each other.

A first U-shaped handgrip part 7 and a second U-shaped handgrip part 37 are provided for movement of the circular saw 1 manually by the operator. Each of the first and second handgrip parts 7, 37 is firmly attached to the safety housing 3. A switch means 8 (including a safety button) is provided on the first handgrip part 7 for electrically connecting the motor 4 to a main power supply via a cable holder 4h attached thereto and a power cord 4p. The safety housing 3 and motor housing 4a are supported by a shoe plate 39 which is guided by the operator along a work-piece during operation. The safety housing 3 is fixed to the shoe plate 39 whereas the housing 4a can be pivoted with respect to the surface of the shoe plate 39.

The first handgrip axis a of the first handgrip part 7 is spaced apart from and essentially perpendicular to the longitudinal shaft axis Y. The second handgrip axis b of the second handgrip part 37 is arranged essentially parallel to the longitudinal shaft axis Y. Both handgrip axes a, b are slightly curved as illustrated in FIGS. 1 and 2. The operator may hold the circular saw 1 with both the first and second handgrip parts 7, 37 during operation.

With respect to the longitudinal shaft axis Y, the first and second handgrip parts 7, 37 are angularly offset by approximately 90°. The second handgrip part 37 is disposed adjacent to the middle section of the first handgrip part 7.

The motor 4, the first and second handgrip parts 7, 37 and the switch means 8 on the first handgrip part 7 are assembled to form a monolithic unit 9. The unit 9 can be rotated by the operator relative to the safety housing 3 around a unit rotation axis which in this embodiment is coincident with the longitudinal shaft axis Y.

As shown in detail in FIGS. 2-4, 6 and 7, the circular saw 1 is equipped with a coupling member 10 for operatively coupling the unit 9 to the safety housing 3. The coupling member 10 is of the bayonet-type containing a female element 11 and a male element 12. The female element 11 is connected to the unit 9 whereas the male element 12 is connected to the safety housing 3. Both the male and female element 11, 12 is essentially ring-shaped. A first coupling portion 11c is an integral part of the female element 11. Correspondingly, a second coupling portion 12c is an integral part of the male element 12.

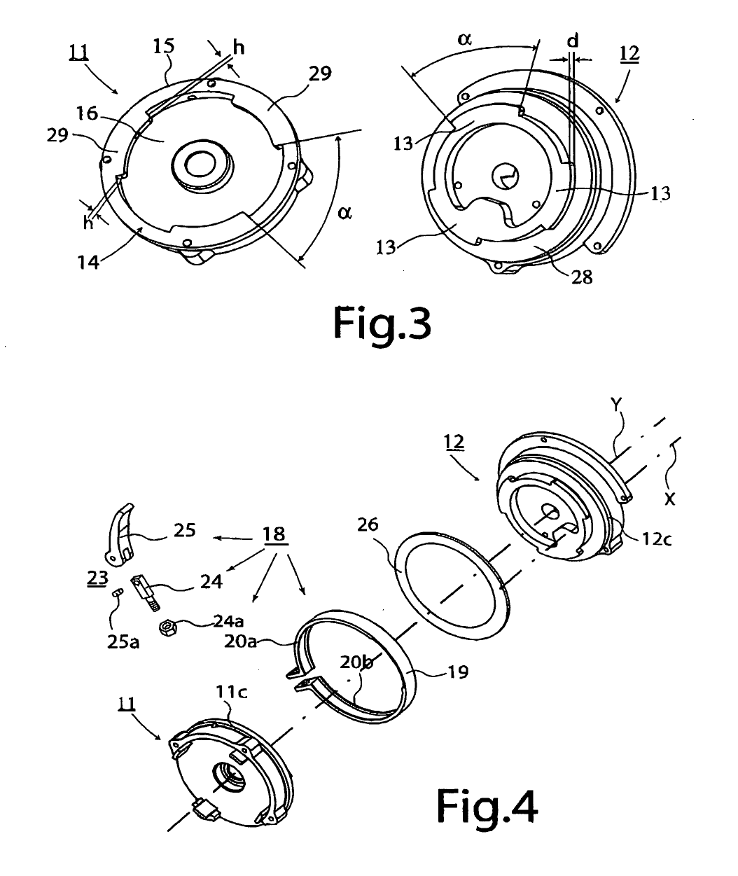

From FIG. 3, it is evident that the female element 11 has three recesses 14 provided in a flange 15 which extends from a cylindrical piece 16 and which are angularly offset from each other (by an angle α) with three teeth 29 of predetermined height h arranged in-between. It will also be evident that the male element 12 has three protrusions 13 which are angularly equidistant (by an amount corresponding to angle α) and which have a predetermined thickness d and three recesses therebetween. The height h of the teeth 29 measured from the cylindrical piece 16 is at least the same as the thickness d of each protrusion 13. The protrusions 13 enter the recesses 14 of the female element 11 by motion along the longitudinal shaft axis Y. After insertion and rotation of the male element 12 by approximately 60° around the longitudinal shaft axis Y, each of the protrusions 13 will be captured by and engaged behind one of the teeth 29 of the female element 11.

In order to avoid accidental unlocking of the protrusions 13 from the corresponding recesses 14 during rotation, the male element 12 and the female element 11 may comprise angle delimiters (not shown in the Figures).

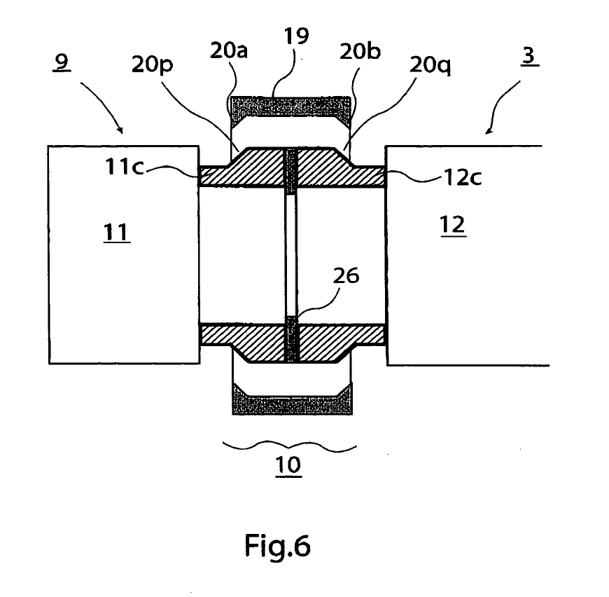

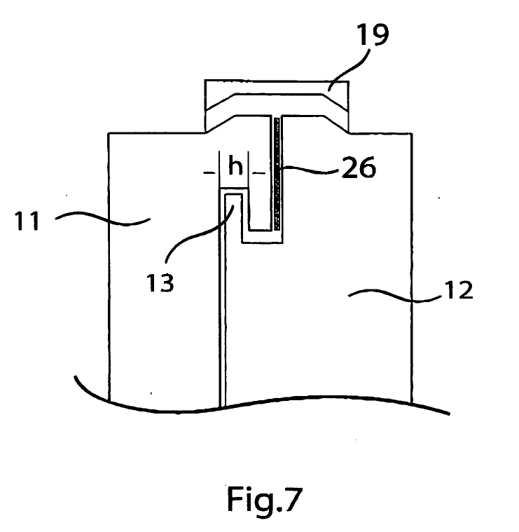

The circular saw 1 is provided with a locking member 18 to prevent the male element 12 and the female element 11 becoming unlocked and separated. The locking member 18 comprises a split ring 19 which is open when not in use. The split ring 19 has on its inner circumference first and second lateral annular extensions 20a, 20b adapted to engage first and second annular recesses 20p, 20q on the outer circumferential surface of the first and second coupling portions 11c, 12c, respectively (see FIGS. 6 and 7). The split ring 19 is slightly flexible and may be made of steel. The recesses 20p, 20q and the extensions 20a, 20b all have oblique walls. When the split ring 19 is closed, a pressure is exerted on the oblique walls. In order to adjust the locking force, the split ring 19 has a screw fastener 23. In particular, the screw fastener 23 comprises a lever 25 attachable by a pin 25a to a threaded holder 24. The end portion of the holder 24 can be screwed on the bent end pieces of the split ring 19 by means of a nut 24a.

A sliding ring 26 is located between the coupling portions 11c, 12c and in the interior of the split ring 19 between extensions 20a, 20b for a sliding rotation between the unit 9 and the safety housing 3. In the illustrated embodiment, the sliding ring 26 is made from a viscose-elastic material such as rubber. Rotation stops as soon as the operator of the circular saw 1 no longer exercises a rotational force on the first and second handgrip parts 7, 37.

The viscose sliding ring 26 between the surfaces of the male element 12 and the female element 11 ensures a smooth and safe motion as the operator seeks to identify a more comfortable sawing position. For this purpose, it is an advantageous feature of the present invention that the user can rotate the first and second handgrip parts 7, 37 even during operation of the circular saw 1. In other words, the operator can change the position of the first and second handgrip parts 7, 37 during operation of the circular saw 1 in a simple and safe manner.

It should be stressed again that in the illustrated embodiments the motor 4, first and second handgrip parts 7, 37, and the switch means 8 together form a unit 9 that is rotational relative to the safety housing 3 around the longitudinal shaft axis Y. Therefore the handgrip parts 7, 37 and the operator's hands can change to a more comfortable position during work.

We claim:

1. A power tool comprising:
a) a tool element for manipulating a workpiece,
b) a tool element housing to accommodate and to support the tool element,
c) a motor having a longitudinal shaft axis,
d) a motor housing for supporting the motor,
e) a transmission device for transferring energy from the motor to the tool element,
f) a handgrip for moving the tool element with respect to the workpiece, wherein the motor housing and the handgrip are a monolithic unit which is rotatable relative to the tool element housing around a unit rotation axis and
g) a coupling member for operatively coupling the unit to the tool element housing.

2. The power tool according to claim 1, wherein the handgrip comprises:
a first handgrip part having a first handgrip axis spaced apart from and essentially perpendicular to the longitudinal shaft axis.

3. The power tool according to claim 1, wherein the handgrip comprises:
a second handgrip part having a second handgrip axis.

4. The power tool according to claim 3, wherein the second handgrip axis is essentially parallel to the longitudinal shaft axis.

5. The power tool according to claim 1, wherein the unit is rotatable by an angle of 90 degrees or less relative to the tool element housing.

6. The power tool according to claim 1, wherein the unit is stepwise rotatable.

7. The power tool according to claim 1, wherein the unit is continuously rotatable.

8. The power tool according to claim 1, wherein whilst the motor is static, the unit is fixable at a desired angular disposition relative to the tool element housing.

9. The power tool according to claim 1, wherein the coupling member comprises:
a sliding mechanism for allowing a sliding rotation between the unit and the tool element housing.

10. The power tool according to claim 9, wherein the coupling member comprises:
a first ring-shaped coupling portion and a second ring-shaped coupling portion, wherein the first coupling portion is firmly connected to the unit and the second coupling portion is firmly connected to the tool element housing, and wherein the sliding mechanism is arranged between the first coupling portion and the second coupling portion.

11. The power tool according to claim 10, wherein a first and a second annular recess are provided on the outer circumferential surface of the first and second coupling portion respectively and wherein the coupling member further comprises:
a split ring composed of a flexible material, wherein the split ring has a first annular extension and a second annular extension on its inner circumferential surface, the first and second recesses being adapted to receive the first and second annular extension respectively and
a closure device for closing the split ring.

12. The power tool according to claim 11, wherein the recesses and the extensions have oblique walls on which a pressure is exerted when the split ring is closed.

13. The power tool according to claim 11, wherein the split ring is made of steel.

14. The power tool according to claim 9, wherein the sliding mechanism is in the form of a ring.

15. The power tool according to claim 1, wherein the tool element is a saw blade.

16. The power tool according to claim 2, wherein the first handgrip axis is slightly curved.

17. The power tool according to claim 3, wherein the second handgrip axis is slightly curved.

18. The power tool according claim 1, wherein the coupling member is of the bayonet-type.

19. The power tool according to claim 17, wherein the bayonet-type coupling member comprises:
a female element connected to or integral with the unit and
a male element connected to or integral with the tool element housing.

20. The power tool according to claim 19, wherein the female element comprises:
a plurality of recesses and a plurality of radial teeth of predetermined height therebetween and wherein the male element comprises:
a plurality of radial protrusions each having a predetermined thickness for insertion into the recesses such that by rotation of the male element around the unit axis, each of the radial protrusions engages the rear of one of the radial teeth.

21. The power tool according to claim 1 further comprising:
a braking system between the unit and the tool element housing.

22. The power tool according to claim 1 further comprising:
a damping element for damping pulses between the tool element housing and the unit.

23. The power tool according to claim 22 wherein the damping element is made of a viscous material or is a shock absorber.

24. The power tool according to claim 1 wherein the unit rotation axis is coincident with the longitudinal shaft axis or an axis parallel thereto.

25. The power tool according to claim 11 wherein the closure device comprises a lever.
